(19) United States
(12) Patent Application Publication
(10) Pub. No.: US 2019/0287348 A1
(43) Pub. Date: Sep. 19, 2019

(54) GAMING SYSTEM, METHOD, AND PROGRAM PRODUCT FOR GENERATING ADDITIONAL PAYOUT CHANCES IN A WAGERING GAME

(71) Applicant: Everi Games, Inc., Austin, TX (US)

(72) Inventors: William Garretsen, Cedar Park, TX (US); Brian Watkins, Austin, TX (US); Clint Owen, Austin, TX (US)

(73) Assignee: Everi Games, Inc., Austin, TX (US)

(21) Appl. No.: 16/431,426

(22) Filed: Jun. 4, 2019

Related U.S. Application Data
(63) Continuation of application No. 13/623,793, filed on Sep. 20, 2012, now abandoned.

(51) Int. Cl. G07F 17/32

(52) U.S. Cl. CPC G07F 17/3265; G07F 17/3218

(57) ABSTRACT

Methods, apparatus, and program products provide for dynamically modifying a symbol matrix, such as a symbol matrix produced in a reel-type game, to provide the player with additional chances to win on a given activation of the game. In particular, one or more initial symbol locations in a matrix of symbol locations may be split so as to replace the respective initial symbol location with two or more symbol locations. The additional symbol locations produced in this way define additional sets of symbol combinations and these additional symbol combinations provide the player with additional chances to win on a given play of the game.

### CROSS-REFERENCE TO RELATED APPLICATION

Applicant claims the benefit, under 35 U.S.C. § 120, of U.S. patent application Ser. No. 13/623,793 filed Sep. 20, 2012, and entitled “Gaming System, Method, and Program Product for Generating Additional Payout Chances in a Wagering Game.” The entire content of this nonprovisional patent application is incorporated herein by this reference.

### BACKGROUND OF THE INVENTION

### 1. Field of the Invention

The present invention relates to wagering games, gaming machines, gaming systems, program products for such gaming machines and gaming systems, and associated methods. More particularly, the invention relates to wagering games which can expand the number of payout chances for a given play of the game.

### 2. Description of the Related Art

Numerous types of wagering games have been developed to provide players with new and varied gaming experiences. One of the techniques which has been used to increase player interest in games is to increase the number of chances for a win on a given play of the game. For example, U.S. Pat. No. 5,807,172 shows a reel-type game (a game which displays results via game symbols appearing on a number of mechanical or video-generated spinnable reels) having additional paylines defined through the matrix of reel symbol locations. The three-reel game shown in this patent provides the player with nine paylines and thus nine chances to produce a winning payline rather than the five paylines available in earlier three-reel games. U.S. Pat. No. 5,580,053 discloses another reel-type game in which non-linear paylines are defined in order to increase the number of paylines which may be active for a given play of the game.

U.S. Patent Application Publication No. 2004/0157659 illustrates another technique which has been used to increase the number of paylines in a reel-type game. This technique includes simply using multiple sets of reels in the gaming machine.

There remains a need in the field of wagering games to provide gaming machines and methods which capture and maintain the player's interest. It is also desirable that the techniques employed to increase player interest are applicable to both reel-type games and other types of games, such as video poker for example.

### SUMMARY OF THE INVENTION

The present invention encompasses methods, apparatus, and program products for dynamically modifying a symbol matrix, such as a symbol matrix produced in a reel-type game, to provide the player with additional chances to win on a given activation of the game. In particular, the invention involves splitting one or more symbol initial locations in a matrix of symbol locations so as to replace the respective initial symbol location with two or more symbol locations. The additional symbol locations produced in this way define additional sets of symbol combinations and these additional symbol combinations provide the player with additional chances to win on a given play of the game.

Embodiments of the invention may be applied to a wagering game which is conducted through a gaming machine adapted to display a primary matrix of primary symbol locations at a display system of the gaming machine. The primary matrix defines a first number of one or more payout chances in the form of combinations of symbols displayed in the various primary symbol locations. The wagering game specifies prizes in a pay table in which a respective prize is correlated to a respective winning symbol combination. For example, where the gaming machine displays a primary matrix having three rows of primary symbol locations with three columns in each row, the pay table may define winning symbol combinations as three particular symbols aligned along a straight line through three adjacent primary symbol locations.

Methods according to the invention may include receiving a game play input through a player input device of the gaming machine and populating at least some of the primary symbol locations of the primary matrix with a respective game symbol for a respective play of the game. In response to the occurrence of a trigger, at least one primary symbol location in the primary matrix is then replaced with two or more secondary symbol locations, and at least two of these secondary symbol locations are each populated with a respective game symbol. This addition of secondary symbol locations in place of a primary symbol location produces a secondary matrix displayed by the gaming machine display system. The secondary matrix is made up of the secondary symbol locations and any remaining primary symbol locations included in the primary matrix, and defines symbol combinations through both the secondary symbol locations and any remaining primary symbol locations so as to define more than the first number of payout chances which were provided by the unmodified primary matrix. Methods according to the invention may then award a prize for each secondary matrix symbol combination which matches a respective winning symbol combination of the pay table.

It should be noted that the symbol location splitting technique is not only applicable to reel-type games. In particular, the invention also has application to video card games such as video poker. In the case of video poker, the primary matrix may be a one-by-five matrix of symbol locations populated (by a deal) each with a respective playing card symbol. In response to the trigger, one or more of the playing card symbols may be replaced by two or more additional playing card symbols displayed in the place of the replaced playing card. The number of additional playing cards which replaced the original playing card may be defined as producing that number of playing card hands, each hand including one of the additional playing cards plus the original cards remaining from the one-by-five matrix.

A gaming machine according to one embodiment of the present invention includes a display system including at least one display device, a player input system, and at least one processor. One or more memory devices are associated with the processor or processors for storing instructions which are executable to populate a primary matrix with game symbols as described above, and to, in response to a trigger, replace one or more of the primary symbol locations with two or more secondary symbol locations to produce the secondary matrix described above. The stored instructions are also executed to award a respective pay table prize for each winning symbol combination defined in the secondary matrix.

Considering that the present invention may be implemented using one or more general purpose processing devices, the invention also encompasses a program product which may be stored on one or more tangible computer readable data storage devices representing non-transitory media. The program product may include player input program code and display program code. The player input program code is executable to receive the game play input for a play of the game, while the display program code is executable to control the display device for each play of the game, for example, according to the method described above to populate the primary symbol locations for each play of the game and to replace one or more of the primary symbol locations with secondary symbol locations, each populated with a respective game symbol. Payout program code may be included which is executable to award a prize for each secondary matrix symbol combination which matches a respective winning symbol combination of the pay table.

These and other advantages and features of the invention will be apparent from the following description of illustrative embodiments, considered along with the accompanying drawings.

### BRIEF DESCRIPTION OF THE DRAWINGS

FIG. 1 is a view in perspective of the front of a gaming machine which may be employed in embodiments of the present invention.

FIG. 2 is a diagrammatic representation of the gaming machine shown in FIG. 1 showing various components of the gaming machine.

FIG. 3 is a diagrammatic representation of a gaming network in which the present invention may be implemented.

FIG. 4 is a flow diagram illustrating a process flow according to one or more embodiments of the present invention.

FIG. 5 is a representation of a reel symbol matrix made up of primary symbol locations according to one embodiment of the present invention.

FIG. 6 is a representation of the reel symbol matrix of FIG. 5 after two of the primary symbol locations have split in response to a triggering event to produce secondary symbol locations according to an embodiment of the present invention.

FIG. 7 is a representation of the reel symbol matrix of FIG. 5 after each primary symbol location in the entire top row of symbol locations has split in response to a triggering event.

FIG. 8 is a representation of the reel symbol matrix of FIG. 5 after each primary symbol location other than the center symbol location has split in response to a triggering event.

FIG. 9 is a representation of a pay table that may be employed in the embodiments shown in FIGS. 5-8.

FIG. 10 is a representation of a playing card symbol matrix made up of primary symbol locations according to another embodiment of the present invention.

FIG. 11 is a representation of the playing card matrix of FIG. 10 after one of the primary symbol locations has been replaced by four secondary symbol locations, each populated with an additional playing card game symbol.

### DESCRIPTION OF ILLUSTRATIVE EMBODIMENTS

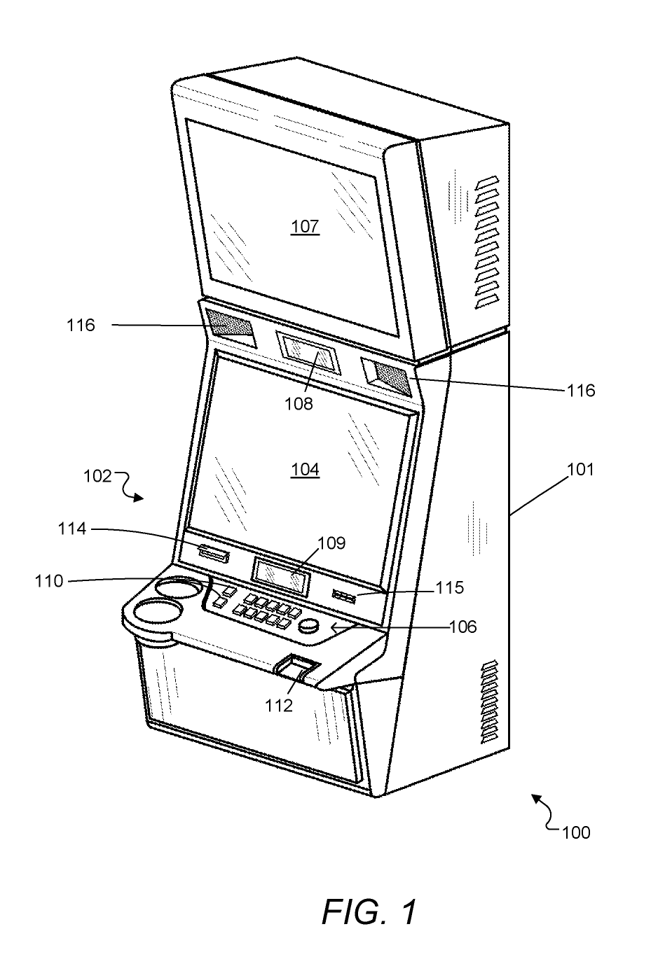

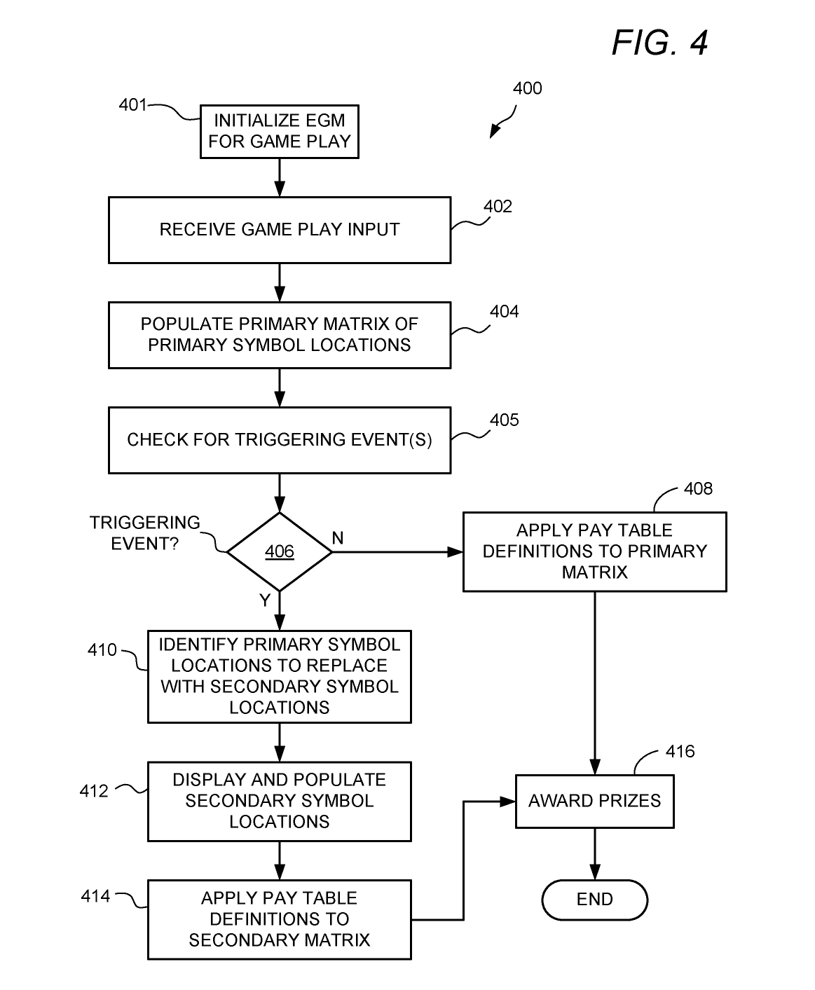

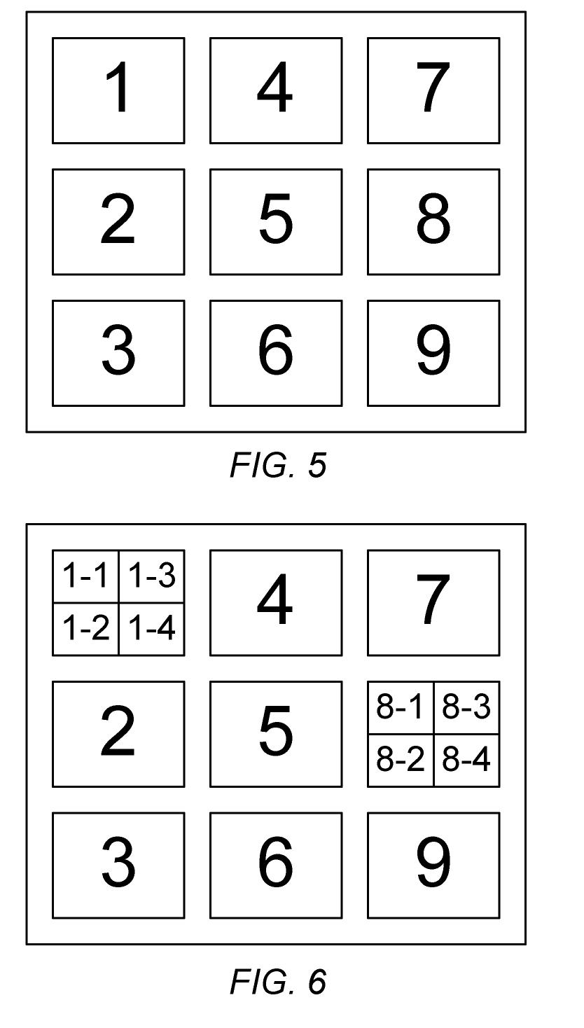

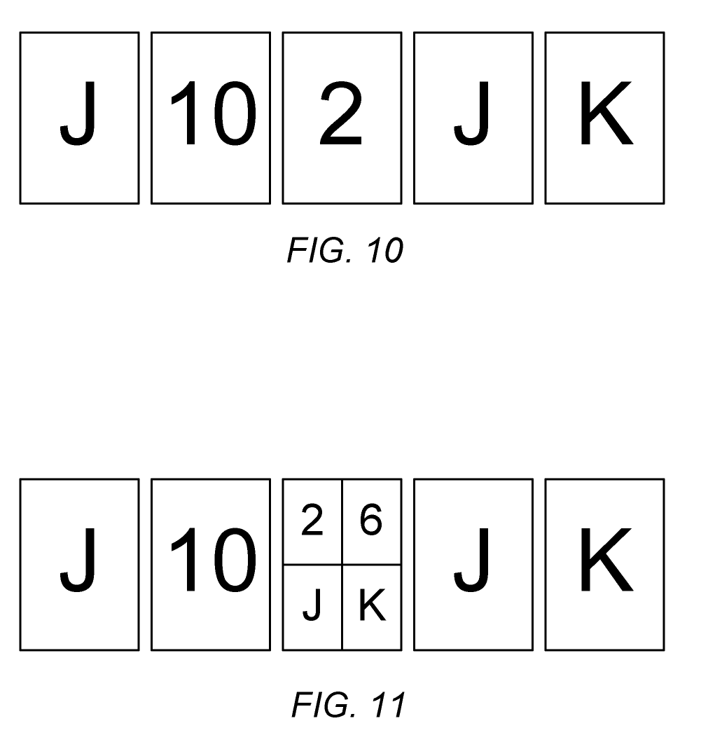

In the following description, FIGS. 1-3 will be used to describe example gaming machines and gaming networks through which the present invention may be implemented. Processes which are illustrative of certain embodiments of the invention will then be described in connection with the flow chart of FIG. 4. Reel-type games embodying the principles of the invention will then be described in connection with FIGS. 5-9, and a playing card game embodying the principles of the invention will be described in connection with FIGS. 10 and 11.

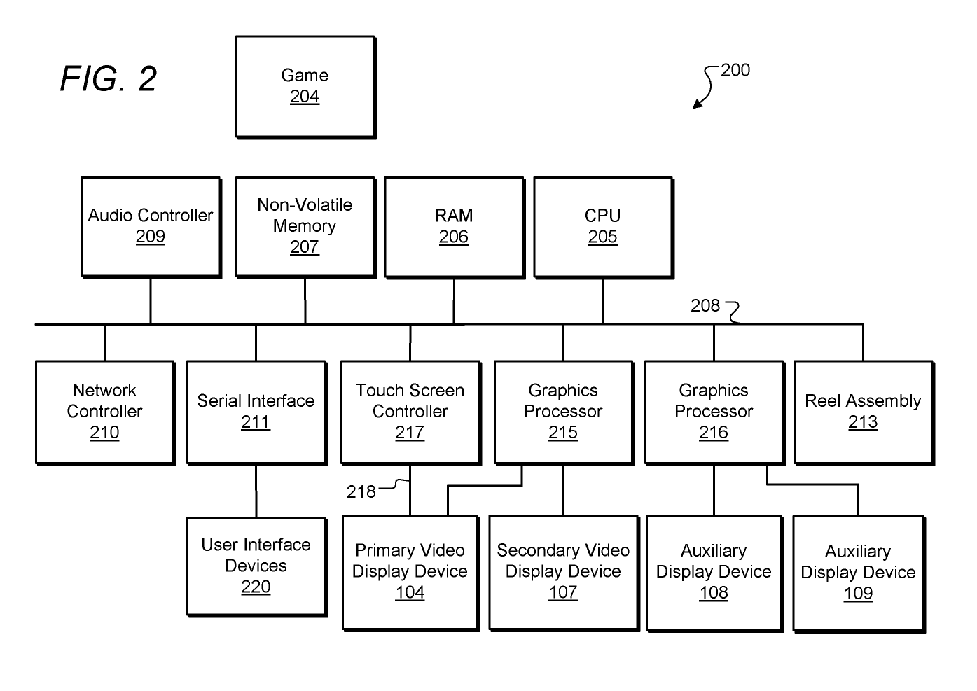

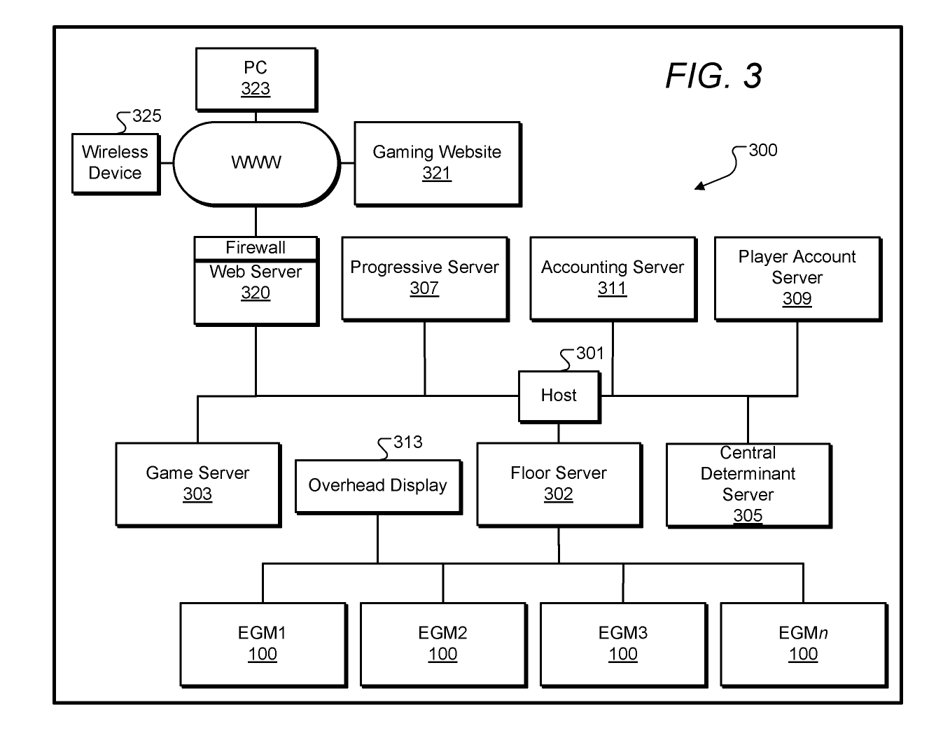

FIG. 1 shows a gaming machine 100 that may be used in implementing a game providing additional payout chances according to the present invention. The block diagram of FIG. 2 shows further details of gaming machine 100 along with certain variations which may be included in the gaming machine. FIG. 3 shows an example gaming network in which gaming machines such as gaming machine 100 may be employed.

Referring to FIG. 1, gaming machine 100 includes a cabinet 101 having a front side generally shown at reference numeral 102. A primary video display device 104 is mounted in a central portion of the front surface 102, with a button panel 106 positioned below the primary video display device and projecting forwardly from the plane of the primary video display device. In addition to primary video display device 104, the illustrated gaming machine 100 includes a secondary video display device 107 positioned above the primary video display device. Gaming machine 100 also includes two additional smaller auxiliary display devices, an upper auxiliary display device 108 and a lower auxiliary display device 109. It should also be noted that each display device referenced herein may include any suitable display device including a cathode ray tube, liquid crystal display, plasma display, LED display, or any other type of display device currently known or that may be developed in the future. One or more of these video display devices, and especially video display device 104, may be used to display game symbols which show the results for a given play of the game implemented through gaming machine 100. Such results may be shown by the manner in which game symbols are aligned along various paylines defined through a symbol location matrix presented by the display device. As will be described further below in connection with FIG. 2 and elsewhere, it is also possible for gaming machines within the scope of the present invention to include mechanical elements such as mechanical reels. However, it is preferable that the symbol location splitting technique described in detail below is shown at least partially by a video display device. Generally, the display device or display devices of the gaming machine, whether video display devices, mechanical devices, or combinations of the two, which are used to display the primary and secondary matrices according to embodiments of the invention, may be described in this disclosure and the accompanying claims as a display system.

The gaming machine 100 illustrated for purposes of example in FIG. 1 also includes a number of mechanical control buttons 110 mounted on button panel 106. These control buttons 110 may allow a player to select a bet level, select pay lines, select a type of game or game feature, and start a play in a game. Other forms of gaming machines through which the invention may be implemented may include switches, joysticks, or other mechanical input devices, and/or virtual buttons and other controls implemented on a suitable touch screen video display. For example, primary video display device 104 in gaming machine 100 provides a convenient display device for implementing touch screen controls in addition to or in lieu of mechanical controls. The player interface devices which receive player inputs to initiate the play of a game through the gaming machine, such as controls to select a wager amount for a given play and control to actually start a given play, may be referred to generally as a player input system.

It will be appreciated that gaming machines may also include a number of other player interface devices in addition to devices that are considered player controls for use in playing a particular game. Gaming machine 100 also includes a currency/voucher acceptor having an input ramp 112, a player card reader having a player card input 114, and a voucher/receipt printer having a voucher/receipt output 115. Numerous other types of player interface devices may be included in gaming machines that may be used to implement embodiments of the present invention.

A gaming machine which may be used to implement embodiments of the present invention may also include a sound system to provide an audio output to enhance the user's playing experience. For example, illustrated gaming machine 100 includes speakers 116 which may be driven by a suitable audio amplifier to provide a desired audio output at the gaming machine.

FIG. 2 shows a logical and hardware block diagram 200 of gaming machine 100 which includes a central processing unit (CPU) 205 along with random access memory (RAM) 206 and nonvolatile memory or storage device 207. All of these devices are connected on a system bus 208 with an audio controller device 209, a network controller 210, and a serial interface 211. A graphics processor 215 is also connected on bus 208 and is connected to drive primary video display device 104 and secondary video display device 107 (both mounted on cabinet 101 as shown in FIG. 1). A second graphics processor 216 is also connected on bus 208 in this example to drive the auxiliary display devices 108 and 109 also shown in FIG. 1. As shown in FIG. 2, gaming machine 100 also includes a touch screen controller 217 connected to system bus 208. Touch screen controller 217 is also connected via signal path 218 to receive signals from a touch screen element associated with primary video display device 104. It will be appreciated that the touch screen element itself typically comprises a thin film that is secured over the display surface of the respective display device, in this case primary video display device 104. The touch screen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer. These elements may be mounted on a standard personal computer chassis and housed in a standard personal computer housing which itself may be mounted in cabinet 101 shown in FIG. 1. Alternatively, the various electronic components may be mounted on one or more circuit boards housed within cabinet 101 without a separate enclosure such as those found in personal computers. Those familiar with data processing systems and the various data processing elements shown in FIG. 2 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 2 as being connected directly on system bus 208 may in fact communicate with the other system components through a suitable expansion bus. Audio controller 209, for example, may be connected to the system via a PCI or PCIe bus. System bus 208 is shown in FIG. 2 merely to indicate that the various components are connected in some fashion for communication with CPU 205 and is not intended to limit the invention to any particular bus architecture. Numerous other variations in the gaming machine internal structure and system may be used without departing from the principles of the present invention. For example, a gaming machine in some embodiments of the present invention may rely on one or more data processors which are located remotely from the gaming machine itself. Embodiments of the present invention may include no processor such as CPU 205 or graphics processors such as 215 and 216 at the gaming machine, and may instead rely on one or more remote processors. Thus unless specifically stated otherwise, the designation “gaming machine” is used in this disclosure and the accompanying claims to designate a system of devices which operate together to provide the indicated functions. A “gaming machine” may include a gaming machine such as gaming machine 100 shown in FIGS. 1 and 2, which is itself a system of various components, and may also include one or more components remote from a gaming machine cabinet (such as cabinet 101 in FIG. 1). Thus the designation “gaming machine” encompasses both a stand-alone gaming machine and a gaming machine (that is, the part housed in a cabinet such as cabinet 101 in FIG. 1) along with one or more remote components for providing various functions (such as generating outcomes for plays in a game, and driving display devices mounted in a gaming machine cabinet).

It will also be appreciated that graphics processors are also commonly a part of modern computer systems. Although separate graphics processor 215 is shown for controlling primary video display device 104 and secondary video display device 107, and graphics processor 216 is shown for controlling both auxiliary display devices 108 and 109, CPU 205 or a graphics processor packaged with or included with CPU 205 may control all of the display devices directly without any separately packaged graphics processor. The invention is not limited to any particular arrangement of processing devices for controlling the video display devices included with gaming machine 100. Also, a gaming machine implementing the present invention is not limited to any particular number of video display device or other types of display devices.

In the illustrated gaming machine 100, CPU 205 executes software, that is, program code, which ultimately controls the entire gaming machine including the receipt of player inputs and the presentation of the graphics or information displayed according to the invention through the display devices 104, 107, 108, and 109 associated with the gaming machine. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for game software such as game program code 204 (and associated program code such as player input program code, display program code, and payout program code) prior to loading into random access memory 206 for execution, or for programs not in use or for other data generated or used in the course of gaming machine operation. Network controller 210 provides an interface to other components of a gaming system in which gaming machine 100 may be included. An example network will be described below in connection with FIG. 3.

It should be noted that the invention is not limited to gaming machines employing the personal computer-type arrangement of processing devices and interfaces shown in example gaming machine 100. Other gaming machines through which the invention may be implemented may include one or more special purpose processing devices to perform the various processing steps for implementing the invention. Unlike general purpose processing devices such as CPU 205, which may comprise an Intel Pentium® or Core® processor for example, these special purpose processing devices may not employ operational program code to direct the various processing steps.

The example gaming machine 100 which may be used to implement some embodiments of the present invention is shown in FIG. 2 as including user interface devices 220 (part of a player input system) connected to serial interface 211. These user interface devices may include various player input devices such as mechanical buttons shown on button panel 106 in FIG. 1, and/or levers, and other devices. It will be appreciated that the interface between CPU 205 and other player input devices such as player card readers, voucher readers or printers, and other devices may be in the form of serial communications. Thus serial interface 211 may be used for those additional devices as well, or the gaming machine may include one or more additional serial interface controllers. However, the interface between peripheral devices in the gaming machine, such as player input devices, is not limited to any particular type or standard for purposes of the present invention.

Reel Assembly 213 is shown in the diagrammatic representation of FIG. 2 to illustrate that a gaming machine which may be used for various embodiments of the invention may include mechanical reels. For example, a set of mechanical reels may replace the primary display device 104, or at least part of that display device. Alternatively, mechanical reels may be included in the gaming machine behind a light-transmissive video display panel. In either case, the mechanical reels either represent a display device for displaying some or all of the game symbols in the course of a game play. It will be appreciated that in order to accommodate symbol location replacement or splitting according to the invention, a mechanical reel must be associated in some way with a variable display arrangement. Such a variable display arrangement may comprise a light transmissive video panel over a mechanical reel or a video display device forming a display surface of at least part of a reel, for example. Although the invention is not limited to any particular mechanical reel arrangement or control system, mechanical reels may be controlled conveniently through serial communications which provide instructions for a respective stepper motor for each reel. Thus some embodiments of the present invention which employ mechanical reels may use a serial interface device such as serial interface 211 to control communications with the reel assembly, and may not include a direct bus interconnection as indicated by FIG. 2. Details of a mechanical reel arrangement and various accent lighting arrangements which may be associated with mechanical reels are not shown in the present figures so as to avoid obscuring the present invention in unnecessary detail.

Referring now to FIG. 3, a networked gaming system 300 associated with one or more gaming facilities may include one or more networked gaming machines 100 (“electronic gaming machines” or “EGM's”) connected in the network by suitable network cable or wirelessly. Networked gaming machines 100 (EGM1-EGMn) and one or more overhead displays 313 may be operatively connected so that the overhead display or displays may mirror or replay the content of one or more displays of gaming machines 100. For example, the primary display content for a given gaming machine 100 may be stored by a display controller or game processor 205 of the given gaming machine and transmitted through network controller 210 to a controller associated with the overhead display(s) 313. In the event gaming machines 100 have cameras installed, the respective players' video images may be displayed on overhead display 313 along with the content of the player's gaming machine display.

The example gaming network 300 shown in FIG. 3 includes a host server 301 and floor server 302, which together may function as an intermediary between floor devices such as gaming machines 100 and back office devices such as the various servers described below. Game server 303 may provide server-based games and/or game services to network connected gaming devices such as gaming machines 100. Central determinant server 305 may be included in the network to identify or select lottery, bingo, or other centrally determined game outcomes and provide the information to networked gaming machines 100 which present the games to players.

Progressive server 307 may accumulate progressive prizes by receiving defined amounts, such as a percentage of the wagers from eligible gaming devices or by receiving funding from marketing or casino funds. Progressive server 307 may also provide progressive prizes to winning gaming devices in response to a progressive event. Such a progressive event may comprise, for example, a progressive jackpot game outcome or other triggering event such as a random or pseudo-random win determination at a networked gaming device or server. Accounting server 311 may receive gaming data from each of the networked gaming devices, perform audit functions, and provide data for analysis programs. Player account server 309 may maintain player account records, and store persistent player data such as accumulated player points and/or player preferences (for example, game personalizing selections or options).

Example gaming network 300 also includes a gaming website 321 which may be hosted through web server 320 and may be accessible by players via the Internet. One or more games may be displayed as described herein and played by a player through a personal computer 323 or handheld wireless device 325 (for example, a Blackberry® cell phone, Apple® iPhone®, personal digital assistant (PDA), iPad®, etc.). To enter website 321, a player may log in with a user name that may, for example, be associated with the player's account information stored on player account server 309. Once logged onto website 321 the player may play various games on the website. Also website 321 may allow the player to make various personalizing selections and save the information so it is available for use during the player's next gaming session at a casino establishment having the gaming machines 100.

It will be appreciated that gaming network 300 illustrated in FIG. 3 is provided merely as an example of a gaming network in which games featuring symbol location replacement according to embodiments of the present invention may be implemented, and is not intended to be limiting in any way. The invention is not limited to use in games offered through a gaming network (via the gaming website 321, or via gaming machines such as gaming machines 100, or otherwise). For example, games including symbol replacement according to the present invention may be offered through a stand-alone gaming machine having a configuration similar to gaming machine 100 or having any other gaming machine configuration. Also, where games including symbol replacement as described particularly below in connection with FIGS. 4-11 are offered through gaming machines included in a gaming network, the network need not have the configuration shown for purposes of example in FIG. 3. In particular, servers shown separately in the example of FIG. 3 may be combined in a single physical processing device, or the processing duties of the various illustrated servers may be split into additional physical devices.

FIG. 4 illustrates an example process within the scope of the present invention. The process shown in FIG. 4 from process block 402 through 416 represents a single game play according to one form of the invention and thus may be repeated for each respective play of the game. The illustrated process applies to a wagering game such as a reel-type game or a playing card game (such as poker) in which the results for a play of the game are shown by the manner in which an array of symbol locations are populated with game symbols for the given play of the game. The following paragraph will describe the overall process shown in FIG. 4 and then subsequent paragraphs will describe the individual process steps in greater detail and describe certain variations on these steps.

As shown at process block 401, the electronic gaming machine (such as gaming machine 100 in FIGS. 1-3) is first initialized for game play. Once the gaming machine is initialized, the process may include receiving a game play input as indicated at process block 402, and then populating the primary matrix of primary symbol locations as indicated at process block 404. Once all of the intended primary symbol locations are populated with a respective game symbol, the process checks for any triggering events as indicated at process block 405. If no triggering event is detected as indicated by a negative outcome at decision box 406, the process branches to apply the pay table definitions to the primary matrix as indicated at process block 408 and to award prizes accordingly as indicated at process block 416. However, if a triggering event is detected as indicated by an affirmative outcome at decision box 406, the process includes identifying primary symbol locations to replace with secondary symbol locations as indicated at process block 410. The secondary symbol locations are then displayed and populated as indicated at process block 412. The process then includes applying the pay table definitions to the secondary matrix as indicated at process block 414, and any indicated prizes are awarded as shown at process block 416. The process then ends for that particular game sequence and, as noted above, the process steps from 402 to 416 may be repeated for each subsequent game play input or activation.

The process of initializing a gaming machine for play of the game as indicated at process block 401 may include a number of different steps depending upon the nature of the gaming machine and the gaming network in which the gaming machine may be included. For example, many modern gaming machines may require a player login to initialize the gaming machine for play. This login may include receiving a player identifier at the gaming machine in some fashion either through a card reader or other reading device or input device at gaming machine. Other gaming machines may require no player login, but may require the player to insert cash or credits into the gaming machine in some fashion to initialize the gaming machine for play. For example, in ticket-in-ticket-out systems, a player may be required to insert a ticket into a ticket reader at the gaming machine to place credits on the gaming machine to facilitate play. Where the gaming machine accepts cash, the initialization process may include receiving cash from the player. Process block 401 is included in FIG. 4 simply to indicate that typically the gaming machine must be initialized for game play in some fashion, but is not intended to limit the invention to any particular type of initialization.

In some forms of the invention the process of initializing the gaming machine for play as indicated at process block 401 causes the gaming machine to display a symbol display area on a symbol display device of the gaming machine. The symbol display area includes a number of symbol locations for a wagering game. In some forms of the invention the state of the symbol display area is simply left over from the previous play of the game. In other embodiments, the state of the symbol display area may be left over from an attract sequence executed by the gaming machine to attract a player to that particular machine. Yet other forms of the invention may return the symbol display area to a particular starting condition for each play the game.

The game play input received as indicated at process block 402 may include receiving a number of separate inputs to initiate the play of the game. For example, a player may be required to select a bet level for the play and/or may be required to select which paylines are active for the given play. The present invention is not limited to receiving any particular input or inputs to initiate the play of the game. Unless stated specifically otherwise, for the purpose of this disclosure and the following claims, the step of receiving a game play input includes receiving any single input or sequence of inputs to initiate the play of the game.

The process of populating at least some of the primary symbol locations with respective game symbols may be accomplished in a number of different ways within the scope of the present invention. Where the gaming machine includes mechanical reels, at least some primary symbol locations are populated by spinning the reels and then bringing each reel to a stop to show various game symbols at the symbol locations. Video reel-type games include a video simulation of reels (which may be shown on primary video display device 104 in FIG. 1 for example) which spin and then come to a stop to show various game symbols in the primary symbol matrix. The invention is not limited to any particular reel arrangement, for either a mechanical reel or video reel implementation. However, each primary symbol location which may be replaced by a set of secondary symbol locations according to the invention requires some mechanism, such as a video device, for showing the modification of the symbol location.

It should be appreciated that some forms of the invention may not change all of the symbols for a/the given play of the game. For example, one or more of the reels in a reel-type game may remain stationary for a given play. Such stationary reels may be selected randomly, may be selected under the control of the player in some fashion, or may be selected in any other fashion. Where the player may select symbol locations to remain constant over the course of the given play of the game, the selection may be part of the game play input at process block 402, for example.

The invention is not limited to any particular arrangement for selecting the game symbols to be displayed at the various primary symbol locations for a given play of the game. In a central determinant system, such as a central determinant bingo or electronic lottery system, for example, a given play of the game may be associated with one or more outcomes of the underlying game. In these cases, the reels of a reel-type game may be forced to stop showing particular symbols consistent with the outcome of the underlying game or random outcome selection. In other forms of the invention the outcome for a given play of the game is obtained in some fashion at the gaming machine itself and the reels are forced to stop showing symbols consistent with the outcome. In yet other forms of invention, the reels may be stopped randomly or pseudo randomly to populate the symbol locations which are to be populated for the given play of the game.

The process of checking for triggering events which would trigger the replacement of a primary matrix symbol with secondary matrix symbol locations will depend significantly on how the trigger event is defined. In some cases, the trigger event may be randomly generated. In these cases, a register or other memory value may be toggled to indicate the occurrence of the trigger, and the occurrence of the triggering event may be checked by evaluating the value or state of the register or other memory location. In other embodiments of the invention, the triggering event may be defined as the occurrence of a particular game symbol at a primary symbol location of the primary matrix. In that case, the evaluation performed according to process block 405 may be an evaluation of each primary symbol location to detect the occurrence of the triggering game symbol. Alternatively, where the game symbols shown at the various primary matrix symbol locations are dictated by a result obtained from a remote device (such as a central determinant server) the occurrence of a triggering game symbol may be apparent from an evaluation of the result from the remote device. The invention is not limited to any particular process or technique for checking for triggering events according to the invention.

The process of identifying primary symbol locations to replace the secondary symbol locations as indicated at process block 410 will vary depending upon the particular rules for replacing the primary symbol locations in a particular embodiment of the invention. For example, where the triggering event is the occurrence of a given game symbol at a primary symbol location, some forms of the present invention may operate to replace that particular symbol location with secondary symbol locations. Alternatively, other embodiments may apply the rule that the occurrence of a particular game symbol at a primary symbol location causes other primary symbol locations to be replaced by secondary symbol locations. The other locations may be defined as one or more adjacent primary symbol locations, all adjacent primary symbol locations, all primary symbol locations other than the symbol location showing the triggering symbol, or any other suitable rule. In embodiments where the trigger for replacing a primary symbol location is random, or perhaps according to a schedule, the particular primary symbol location which is replaced may be identified at random or according to any suitable rule. In yet other embodiments of the invention, a player may be allowed to select the particular primary symbol location which is to be replaced with secondary symbol locations. In this case the step at process block 410 includes applying the selection or selections entered by the player at the gaming machine.

The invention encompasses a number of different techniques for displaying and populating the secondary symbol locations. These techniques typically involve the use of a video display that displays the primary symbol location to be replaced and/or the secondary symbol locations which are shown in place of the primary symbol location. For games other than reel-type games, the primary symbol locations may be displayed on a video display and displaying the secondary symbol locations simply includes modifying the video to show two or more secondary symbol locations. Any suitable graphics may be used to display the game symbols which populate the secondary symbol locations. For reel-type games, the area of the primary symbol location may be replaced by two or more video-generated simulated reels which are then shown to spin and ultimately come to rest to show the game symbols at the secondary symbol locations. Where a mechanical reel is used to display the primary symbol location to be replaced, the mechanical reel may underlay a light transmissive video display which is activated to display secondary symbol locations over the primary symbol location. Otherwise, the mechanical reel may carry a video display device to display the primary symbol location to be replaced, and may also display the secondary symbol locations.

The process of applying the pay table definitions to the primary matrix according to process blocks 408 and 414 may encompass evaluating the game symbols at the various primary symbol locations to identify winning combinations of symbols which are defined in the applicable pay table. Determining which game symbols are displayed at the various primary symbol locations may involve evaluating the reel stop position for a mechanical or video reel to identify the game symbols which are displayed. However where the reel stop positions are dictated by a result such as a central determinant result, the game symbols displayed at each respective primary symbol location may be apparent from the result itself. Ultimately the application of the pay table definitions as indicated at process block 408 and 414 will result in the identification of any prizes that are to be awarded for the particular play of the game.

The difference between the processes shown at process block 408 and 414 is that according to process block 414, the pay table definitions are applied to the secondary matrix which by definition will include more symbol combinations than the symbol combinations defined through the primary matrix applied according to process block 408. This difference will be described further below in connection with the specific examples shown in FIGS. 5 through 11.

The prizes that may be awarded in accordance with process block 416 may be awarded in any particular fashion consistent with the particular gaming machine and gaming system. For example, prizes are awarded in some gaming machines by increasing the credit value on the gaming machine and the player may cash out from that gaming machine to obtain value for those credits. Other types of gaming systems maintain an account for the player's play at a remote accounting system, and the prizes are awarded by crediting the player's remote account and showing the updated account value at the gaming machine. Some types of prizes may be hand pay prizes which require a casino employee to manually deliver the prize or a voucher for the prize to the player. Hand pays are typically required for high-value prizes or for prizes in the form of merchandise or coupons. Other types of gaming machines may physically dispense prizes in the form of coins or other value. The invention is not limited to any particular system or arrangement for awarding the pay table prizes.

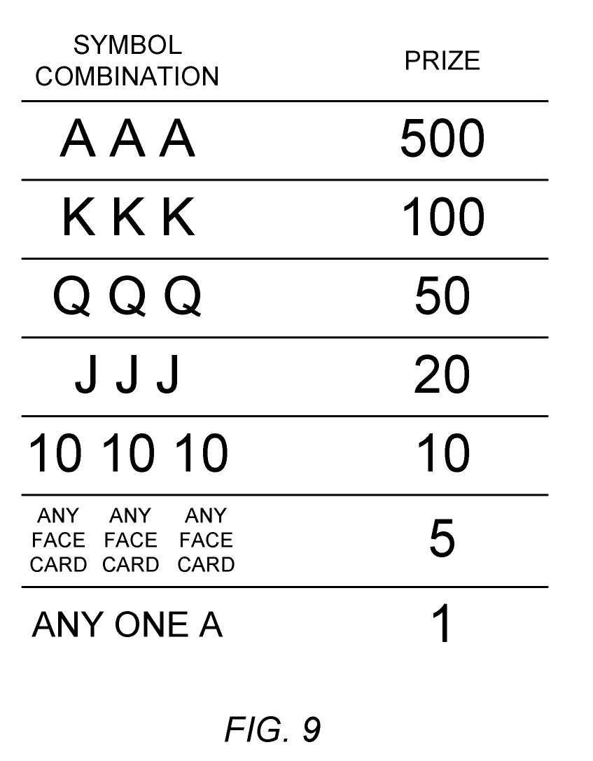

Specific examples of a process according to the invention may be described with reference to FIGS. 5 through 8 and the example pay table shown in FIG. 9. The pay table of FIG. 9 shows a number of different symbol combinations which are correlated to a numerical prize value. The symbols used in this example pay table are the Ace symbol (A), King symbol (K), Queen symbol (Q), Jack symbol (J) and 10 card symbol (10). FIG. 5 provides a diagrammatic representation of a primary matrix that may be displayed in a reel-type game implementation of the present invention. This example primary matrix includes nine separate primary symbol locations designated symbol locations 1 through 9 in the figure. FIG. 6 provides a diagrammatic representation of a secondary matrix produced from the primary matrix shown in FIG. 5 after primary symbol locations 1 and 8 in FIG. 5 have been replaced by a number of secondary symbol locations. For purposes of this example, symbol locations 1 and 8 of FIG. 5 have been replaced with four separate secondary symbol locations each, labeled 1-1, 1-2, 1-3, and 1-4 in place of primary symbol location 1 (in FIG. 5) and 8-1, 8-2, 8-3, and 8-4 for primary symbol location 8 (in FIG. 5).

Assuming that winning symbol combinations are limited to linear arrangements of three symbol locations in accordance with the example pay table shown in FIG. 9, the primary matrix shown in FIG. 5 includes a maximum of eight symbol location combinations that could form a winning combination according to the example pay table in FIG. 9. In particular, this primary matrix defines three vertical rows of primary symbol locations, three vertical columns of symbol locations, and two diagonal lines of symbol locations. In contrast, the example secondary matrix shown in FIG. 6 defines many more symbol combinations that may produce a winning combination of symbols according to the example pay table. For example, where the primary matrix of FIG. 5 defines a single top row of primary symbol locations, (namely, locations 1, 4, and 7), the secondary matrix of FIG. 6 defines four symbol location combinations that may produce a winning combination of symbols, namely the following combination:

1-1, 1-3, 4,

1-3, 4, 7

1-2, 1-4, 4

1-4, 4, 7.

Similarly the secondary matrix shown in FIG. 6 defines four separate horizontal symbol location combinations with the remaining primary symbol locations 2 and 5. Also, where the first and last column of three symbol locations in the primary matrix of FIG. 5 defines only two primary symbol location combinations (namely, combinations made up of symbol locations 1, 2, 3 and 7, 8, 9), the secondary matrix of FIG. 6 defines four vertical sets of three symbol location combinations each for the corresponding columns, namely.

1-1, 1-2, 2

1-2, 2, 3

1-3, 1-4, 2

1-4, 2, 3

7, 8-1, 8-2

8-1, 8-2, 9

7, 8-3, 8-4

8-3, 8-4, 9

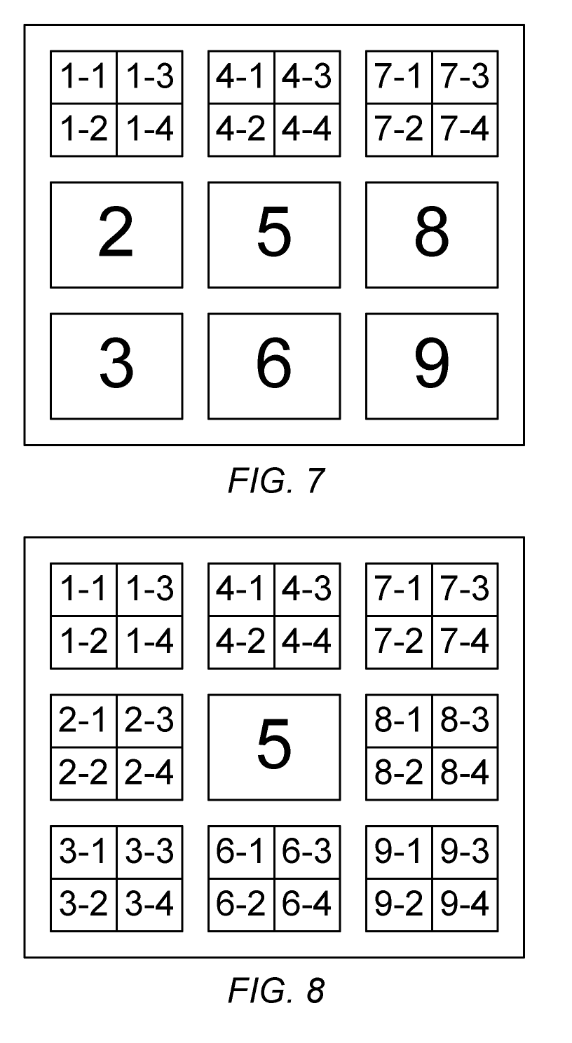

FIGS. 7 and 8 each show another secondary matrix that may be formed from the primary matrix shown in FIG. 5. In the case of FIG. 7, each primary symbol location of the top row of symbol locations of FIG. 5 has been replaced by a respective set of secondary symbol locations. In the case of FIG. 8, each primary symbol location from the primary matrix of FIG. 5 other than the middle location 5 has been replaced with a respective set of secondary symbol locations. Again, the replacement of the game symbol at a given primary matrix location with multiple secondary matrix locations, each with a respective game symbol, increases the number of symbol combinations which may produce a winning symbol combination according to the pay table for the primary matrix.

Any number of triggering events may be applied to produce the secondary matrices shown in FIGS. 6, 7, and 8 from the primary matrix shown in FIG. 5. For example, in the case of the transformation from the primary matrix of FIG. 5 to the secondary matrix of FIG. 6, the primary symbol location 1 and 8 in FIG. 5 may have been populated (in accordance with process block 404 in FIG. 4) with game symbols designated as trigger symbols. The occurrence of the trigger symbol at primary symbol location 1 in FIG. 5 may have prompted the replacement of that primary symbol location with the secondary symbol locations 1-1, 1-2, 1-3, and 1-4 shown in FIG. 6, whereas the occurrence of the trigger symbol at primary symbol location 8 in FIG. 5 may have prompted the replacement of that primary symbol location with the secondary symbol locations 8-1, 8-2, 8-3, and 8-4 in FIG. 6.

However, the replacement of a given primary symbol location with a set of secondary symbol locations according to the invention is not limited to the mechanism of a given trigger symbol landing in the primary symbol location in the course of populating the symbol locations of the primary matrix. For example, symbol locations 1 and 8 in FIG. 5 may have been randomly selected to be replaced by secondary symbol locations regardless of the game symbol which may have landed at those primary symbol locations for the given play of the game. Alternatively, those symbol locations may have been replaced in response to a player input at the gaming machine, such as the selection of those primary symbol locations by the player. In the case of player selection, the selection may have been entered in any suitable fashion such as via a touch of the respective primary symbol location where the display device comprises a touch screen display. Also, the player input may be at any suitable point in the game play process, such as prior to the time the primary symbol locations are populated with game symbols or after the primary symbol locations have been populated. Furthermore, even where a game symbol is defined as a trigger symbol which prompts the replacement of a primary symbol location with a set of secondary symbol locations, the replacement need not be at the particular primary symbol location on which the trigger symbol lands. Rather, the triggering event rules defined for a game according to the present invention may dictate that where a trigger symbol lands at a given primary symbol location, one or more adjacent primary symbol locations are to be replaced with a respective set of secondary symbol locations. In the case of FIG. 7 for example, a trigger symbol may have landed at a primary symbol location in the top row of the primary matrix (symbol locations 1, 4, and 7 of FIG. 5) and this occurrence may have prompted each primary symbol location of the top row to be replaced by the respective set of secondary symbol locations shown in FIG. 7. In the case of FIG. 8 for example, the trigger symbol may have landed at primary symbol location 5 (in the primary matrix of FIG. 5) and may have prompted every other symbol location to be replaced by the respective set of secondary symbol locations shown in FIG. 8.

It should be noted that the invention provides flexibility in the manner in which the symbol location combinations are defined through the secondary matrix. Taking the example of the secondary matrix shown in FIG. 6, it is possible to apply either of the following two definitions for the symbol combinations along the top row of symbol locations including secondary symbol locations 1-1, 1-2, 1-3, and 1-4, and primary symbol locations 4 and 7:

| Option 1 | Option 2 |
|---|---|
| 1-1, 1-3, 4 | 1-1, 4, 7 |
| 1-3, 4, 7 | 1-3, 4, 7 |
| 1-2, 1-4, 4 | 1-2, 4, 7 |
| 1-4, 4, 7 | 1-4, 4, 7 |

The rules of the particular game will specifically define which of these definition options applies for a particular play of the game.

It should also be noted that regardless of which definition option is applied in the example noted in the preceding paragraph, the example pay table of FIG. 9 may be applied to identify winning symbol combinations formed exclusively through primary symbol locations, exclusively through secondary symbol locations, or through a combination of primary and secondary symbol locations. That is, any symbol combination of three adjacent game symbols (where “adjacent” is defined as noted in the preceding paragraph) that matches one of the combinations shown in the pay table will produce the corresponding prize for that symbol combination. For example, assuming the definition of Option 1 above, if symbol locations 1-1, 1-3, and 4 in the secondary matrix of FIG. 6 are each populated with an “A” symbol (that is, an Ace symbol), then that symbol combination would be entitled to a prize of 500 credits according to the pay table of FIG. 9. As another example, if there are no triggers to trigger the appearance of secondary symbol locations for a given play of the game employing the primary matrix shown in FIG. 5, then if the symbol locations 1, 4, and 7 are each populated with an “A” (Ace) symbol, then that symbol combination would be entitled to a prize of 500 credits according to the pay table of FIG. 9. The same pay table, with the same definitions applies to both the primary matrix of FIG. 5 and the secondary matrix of FIG. 6.

Although the pay table shown in FIG. 9 includes only winning symbol combinations comprising three adjacent symbols, it will be appreciated that a pay table that applies to the primary matrix of FIG. 5 and the secondary matrices of FIGS. 6-8 may additionally define winning symbol combinations having four, five, or even six adjacent symbols in a straight line. This is because it is possible to produce such a combination of game symbols through a secondary matrix, depending upon which primary symbol locations are replaced with secondary symbol locations. For example, the top row of secondary symbol locations in the secondary matrix of FIG. 7 includes six adjacent symbol locations, namely, the set of secondary symbol locations 1-1, 1-3, 4-1, 4-3, 7-1, and 7-3. Thus it is possible that each of these secondary symbol locations could be populated with a symbol such as the “A” (Ace) symbol, and a prize may be defined in the pay table for a combination of six “A” symbols.

The previous examples of FIGS. 5 through 9 may be implemented as a reel-type game. However, the invention is not limited to reel-type games. FIGS. 10 and 11 show an implementation of the invention applied to a video-generated playing card game, particularly, a five card poker game. A pay table for this game may be defined in terms of the playing card hand hierarchy so that, for example, a hand producing a pair may have a certain prize value, a hand producing three-of-a-kind may have a certain prize value, and so forth. FIG. 10 shows that the initial deal in the poker game populates five primary symbol locations each with a game symbol comprising a representation of a playing card. The example playing card hand defined by the primary matrix comprises a Jack (J), 10, 2, Jack, and King (K) (the card suits are not considered for purposes of this example). FIG. 11 shows that the 2 card has, in response to some triggering event, been replaced with four secondary symbol locations, each of which has been populated with a respective playing card representation (game symbol). According to one rule for applying the secondary game symbols, each respective secondary game symbol is considered with the remaining primary game symbols to define a respective playing card hand. In this particular example, the resulting playing card hands would be as follows.

| Hand | Value |
|---|---|
| Jack, 10, 2, Jack, King | Pair of Jacks |
| Jack, 10, Jack, Jack, King | Three Jacks |
| Jack, 10, 6, Jack, King | Pair of Jacks |
| Jack, 10, King, Jack, King | Two Pair |

Thus according to this example method of applying the symbols populating the secondary matrix, the play of the game gives the player four separate chances for a winning hand. In contrast, the primary matrix shown in FIG. 10 provides only a single chance at a winning hand.

In the case of the playing card game example, the triggering event may be defined as the occurrence of a particular game symbol (such as a 2 card for example), which may be generated randomly aside from the initial deal, may be a player input, or may be defined in any other suitable way. The playing cards used to populate the secondary symbol locations may be identified in any suitable fashion, for example, drawn from a randomly arranged set of remaining cards from an electronically defined deck of cards.

The present invention employing sets of replacement symbols may be applied in many different settings within the scope of the present invention. For example, although the reel-type game shown in FIGS. 5 through 9 comprises a three-by-three matrix of primary symbol locations, a primary matrix within the scope of the present invention may be any size, such as a three-by-five set of primary symbol locations. The number of secondary symbol locations which may replace a given primary symbol location may be any number of two or more, and not just the set of four secondary symbol locations shown for purposes of example in FIGS. 6 through 8. Also, each primary symbol location and each secondary symbol location may be shown by a separate reel for reel-type game implementations, or a single reel may show multiple primary symbol locations or multiple secondary symbol locations. Furthermore, the replacement symbol mechanic described above may be applied to primary games, bonus games, secondary games, free games, or any other type of games which may be offered through a gaming machine. The game symbols used to populate the secondary symbol locations may be selected from the same set of game symbols used to populate primary symbol locations, a larger set, a smaller set, or an entirely different set of game symbols.

Another variation within the scope of the present invention includes providing multiple iterations of replacing symbol locations with additional symbol location sets. For example, once the secondary symbol locations are displayed and populated in accordance with process block 412 and FIG. 4, the system may again check for triggering events. Any such new triggering event may cause one of the remaining primary symbol locations to be replaced with a set of secondary symbol locations, or may cause one of the secondary symbol locations to be replaced with a set of tertiary symbol locations. Each additional secondary locations and/or tertiary symbol locations may be populated with a game symbol to further increase the available location combinations which may form winning combinations through the resulting matrix.

Although example implementations of the invention are described above mostly in terms of standalone games, it should be appreciated that the invention may be applied in any number of different gaming environments and/or in combination with other games. For example, games employing symbol location replacement according to the present invention may be used as in-revenue or out-of-revenue tournament games or in side action games that are played in parallel or concurrently with one or more other games. Games employing symbol location replacement may also be employed as community games in which results at one gaming machine affect a community of one or more other players at different gaming machines. Games employing symbol location replacement may also employ additional features to enhance the player's gaming experience. For example, players may be allowed to save game symbols from one play (including trigger symbols) and apply the saved symbols to another play. This may be accomplished by freezing one or more reels for a given play of a reel-type game. Also, games employing symbol location replacement may incorporate progressive prizes. For example, one or more prizes in the applicable pay table may comprise a respective progressive prize. Avatars are among other game features which may be used in connection with games employing symbol location replacement. For example, an avatar may be used to select a primary symbol location to be replaced. Trailing touch screen graphic effects such as those disclosed in U.S. Patent Application Publication No. 2012/0115599 may also be incorporated in games employing symbol location replacement.

As used in the foregoing description and the following claims, the terms “comprising,” “including,” “carrying,” “having,” “containing,” “involving,” and the like are to be understood to be open-ended, that is, to mean including but not limited to. Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above-described example embodiments are intended to illustrate the principles of the invention, but not to limit the scope of the invention. Various other embodiments and modifications to these preferred embodiments may be made by those skilled in the art without departing from the scope of the present invention.

1. A method conducted through a gaming machine, the method including:
(a) under control of a processor associated with the gaming machine, displaying a gaming interface including a primary matrix of primary symbol locations at a display system, and specifying prizes in a pay table in which a respective prize is correlated to a respective winning symbol combination;
(b) under control of the processor, receiving a game play input through a player input device of the gaming machine;
(c) under control of the processor, populating the primary symbol locations of the primary matrix with respective game symbols for that respective game play input so as to define a first number of one or more payout chances through the primary matrix;
(d) under control of the processor, after (c), determining if a trigger occurs in the populated primary matrix and, in response to a trigger, providing additional payout chances while maintaining a size and position of the primary matrix on the display system by replacing at least one primary symbol location in the primary matrix with two or more respective secondary symbol locations occupying an area of a single one of the primary symbol locations, and populating at least two of the secondary symbol locations each with a respective randomly selected game symbol to produce a secondary matrix displayed by the display system, the secondary matrix made up of the secondary symbol locations and any remaining primary symbol locations included in the primary matrix, the secondary matrix defining symbol combinations through both the secondary symbol locations and any remaining primary symbol locations so as to define more than the first number of payout chances; and
(e) under control of the processor, awarding a prize for each secondary matrix symbol combination which matches a respective winning symbol combination of the pay table.

2. The method of claim 1 wherein the primary matrix comprises a matrix of primary symbol locations defined by reels of a reel-type game, and wherein for each replaced primary symbol location, the respective secondary symbol locations are provided by two or more secondary reels shown in place of the respective replaced primary symbol location.

3. The method of claim 1 wherein the trigger comprises the occurrence of a trigger symbol at one of the primary symbol locations.

4. The method of claim 3 wherein the occurrence of the trigger symbol at a respective primary symbol location causes that primary symbol location to be replaced with two or more secondary symbol locations.

5. The method of claim 3 wherein the occurrence of the trigger symbol at a respective primary symbol location causes one or more other primary symbol locations to each be replaced with two or more respective secondary symbol locations.

6. The method of claim 1 wherein at least one primary symbol location is replaced with four or more secondary symbol locations.

7. The method of claim 1 wherein the trigger comprises a player input entered through the gaming machine to select one or more primary symbol locations to each be replaced by two or more secondary symbol locations.

8. The method of claim 1 wherein each primary symbol location is populated with a playing card for a playing card game, and wherein the pay table for the playing card game defines prizes according to a hierarchy of playing card hands.

9. A gaming machine including:
(a) a display system;
(b) a player input system;
(c) at least one processor; and
(d) at least one memory device storing instructions executable by the at least one processor to:
cause the display system to display respective game symbols the primary symbol locations of a primary matrix, the primary matrix of primary symbol locations defining a first number of one or more payout chances for a wagering game in which prizes are specified in a pay table which correlates a respective prize to a respective winning symbol combination;
(ii) after (i), determining if a trigger occurs in the populated primary matrix and in response to a trigger, providing additional payout chances while maintaining a size and position of the primary matrix on the display system by causing at least one primary symbol location displayed on the display system to be replaced by two or more respective secondary symbol locations occupying an area of a single one of the primary symbol locations, each secondary symbol location with a respective randomly selected game symbol, the secondary symbol locations and any remaining primary symbol locations included in the primary matrix defining a secondary matrix which includes symbol combinations through both the secondary symbol locations and any remaining primary symbol locations; and
(iii) award a respective pay table prize for each winning symbol combination defined in the secondary matrix.

10. The gaming machine of claim 9 wherein the at least one processor causes the display system to display the primary symbol locations as being defined by reels of a reel-type game, and wherein the at least one processor causes the display system to display the secondary symbol locations as being defined by two or more secondary reels shown in place of the respective primary symbol location which is replaced.

11. The gaming machine of claim 9 wherein the trigger comprises the occurrence of a trigger symbol at one of the primary symbol locations, and the at least one processor executes instructions to detect the occurrence of the trigger symbol.

12. The gaming machine of claim 11 wherein, upon the occurrence of the trigger symbol at a respective primary symbol location, the at least one processor executes instructions to cause the display system to replace that respective primary symbol location with two or more secondary symbol locations.

13. The gaming machine of claim 11 wherein, upon the occurrence of the trigger symbol at a respective primary symbol location, the at least one processor executes instructions to cause the display system to replace one or more other primary symbol locations each with two or more secondary symbol locations.

14. The gaming machine of claim 9 wherein the trigger comprises a player input entered through the player input system, and the at least one processor executes instructions to detect the occurrence of the trigger.

15. The gaming machine of claim 9 wherein:
(a) the at least one processor executes instructions to cause the display system to display a playing card at each primary symbol location of the primary matrix, and to cause the display system to display a respective playing card at each secondary symbol location of the secondary matrix; and
(b) the pay table defines prizes according to a hierarchy of playing card hands.

16. A program product stored on one or more non-transitory computer readable data storage devices, the program product including:
(a) player input program code executable by at least one processor to receive a game play input entered through a player input system of a gaming machine;
(b) display program code executable by the at least one processor to cause a display system associated with the gaming machine to (i) display respective game symbols at primary symbol locations of a primary matrix, the primary matrix of primary symbol locations defining a first number of one or more payout chances for a wagering game in which prizes are specified in a pay table which correlates a respective prize to a respective winning symbol combination, and to (ii) after (i), determine if a trigger occurs in the game symbols displayed in the primary matrix and in response to a trigger, provide additional payout chances while maintaining a size and position of the primary matrix on the display system by replacing at least one primary symbol location with two or more respective randomly selected secondary symbol locations in place of a single one of the primary symbol location with each of the two or more symbol locations containing a respective game symbol, the secondary symbol locations and any remaining primary symbol locations included in the primary matrix defining a secondary matrix which includes symbol combinations through both the secondary symbol locations and any remaining primary symbol locations; and
(c) payout program code executable by the at least one processor to award a prize for each secondary matrix symbol combination which matches a respective winning symbol combination of the pay table.

17. The program product of claim 16 wherein the display program code is executable to cause the display system to display the primary symbol locations as being defined by reels of a reel-type game, and to cause the display system to display the secondary symbol locations as being defined by two or more secondary reels shown in place of the respective primary symbol location which is replaced.

18. The program product of claim 16 wherein the display program code is executable to, upon the occurrence of the trigger at a respective primary symbol location, cause the display system to replace that respective primary symbol location with two or more secondary symbol locations.

19. The program product of claim 16 wherein the display program code is executable to, upon the occurrence of a trigger symbol at a respective primary symbol location, cause the display system to replace one or more other primary symbol locations each with two or more secondary symbol locations.

20. The program product of claim 16 wherein:
(a) the display program code is executable to cause the display system to display a respective playing card as the game symbol at each primary symbol location of the primary matrix, and to cause the display system to display a respective playing card as the game symbol at each secondary symbol location of the secondary matrix; and
(b) the pay table defines prizes according to a hierarchy of playing card hands.
